(19) United States
(12) Patent Application Publication
(10) Pub. No.: US 2024/0243514 A1
(43) Pub. Date: Jul. 18, 2024

(54) CONNECTOR

(71) Applicant: YAZAKI CORPORATION, Tokyo (JP)

(72) Inventors: Satoki Masuda, Makinohara-shi (JP); Yoshinao Sato, Kakegawa-shi (JP)

(21) Appl. No.: 18/398,126

(22) Filed: Dec. 27, 2023

(30) Foreign Application Priority Data
Jan. 18, 2023 (JP) 2023-005986

(51) Int. Cl. H01R 13/52

(52) U.S. Cl. CPC H01R 13/5219

(57) ABSTRACT

A connector includes a housing that holds a terminal connected to a connection target, and includes a fitting part that is inserted into a fitting hole formed in the connection target; and a seal member that is attached to an outer periphery of the fitting part, and comes in contact with an inner face of the fitting hole to stop water between the housing and the connection target. The seal member is formed with an oil-impregnated elastic member, and includes at least a first lip and a second lip provided to protrude from an outer peripheral face while being lined along a connection direction with respect to the connection target. The first lip is provided on the connection target side of the second lip, and a protrusion length of the first lip is shorter than a protrusion length of the second lip.

### CROSS-REFERENCE TO RELATED APPLICATION(S)

The present application claims priority to and incorporates by reference the entire contents of Japanese Patent Application No. 2023-005986 filed in Japan on Jan. 18, 2023.

### BACKGROUND OF THE INVENTION

### 1. Field of the Invention

The present invention relates to a connector.

### 2. Description of the Related Art

Conventionally, there is a connector as disclosed in Japanese Patent Application Laid-open No. 2022-032605, for example, that is equipped with an annular seal member (water sealing member) attached to a housing so that the seal member stops water between the housing and a connection target (mating device).

Such a connector has room for improvement in that it may have difficulty connecting to a connection target. For example, a connector is connected to a connection target by moving a seal member while in contact with a fitting part of the connection target. At this time, when the coefficient of friction between the seal member and the fitting part is high, a large insertion force is required to connect the connector, and connection of the connector to the connection target may not be achieved smoothly.

### SUMMARY OF THE INVENTION

It is therefore an object of the present invention to provide a connector capable of achieving connection to a connection target smoothly.

In order to achieve the above mentioned object, a connector according to one aspect of the present invention includes a housing that holds a terminal connected to a connection target, the housing including a fitting part that is inserted into a fitting hole formed in the connection target; and a seal member that is attached to an outer periphery of the fitting part, the seal member coming in contact with an inner face of the fitting hole to stop water between the housing and the connection target, wherein the seal member is formed with an oil-impregnated elastic member, and includes at least a first lip and a second lip provided to protrude from an outer peripheral face while being lined along a connection direction with respect to the connection target, the first lip is provided on the connection target side of the second lip, and a protrusion length of the first lip is shorter than a protrusion length of the second lip.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment;

FIG. 2 is an exploded perspective view illustrating the connector according to the embodiment;

FIG. 3 is an enlarged view of a seal member of the connector according to the embodiment;

FIG. 4 is an explanatory diagram when connecting the connector according to the embodiment; and

FIG. 5 is an explanatory diagram when connecting the connector according to the embodiment.

### DETAILED DESCRIPTION OF THE PREFERRED EMBODIMENTS

Hereinafter, an embodiment according to the present invention will be described in detail with reference to the accompanying drawings. Note, however, that the present invention is not limited by the embodiment. Furthermore, structural components in the following embodiment include those that can be easily replaced by those skilled in the art, or those that are substantially the same.

### Embodiment

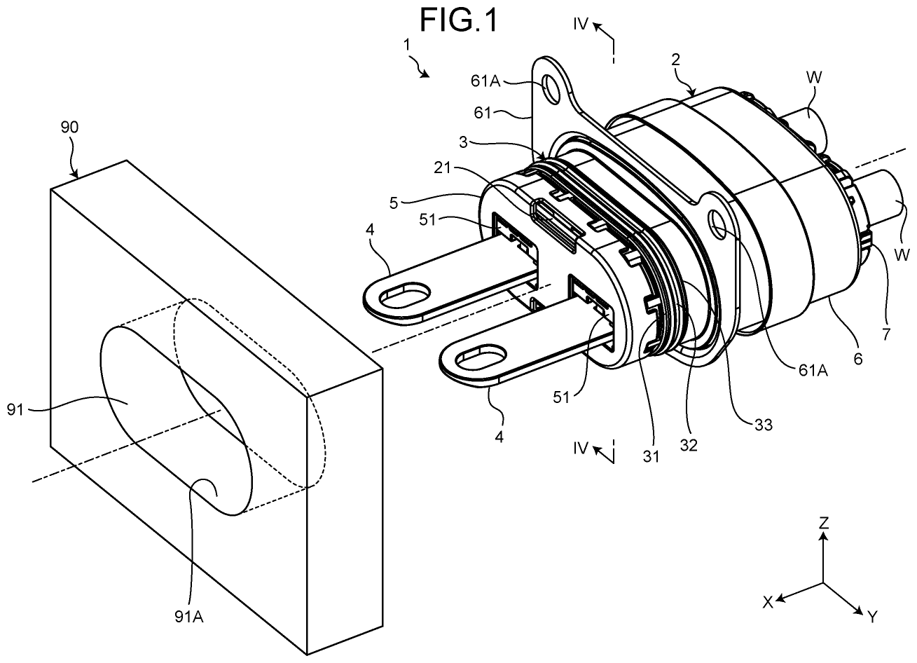

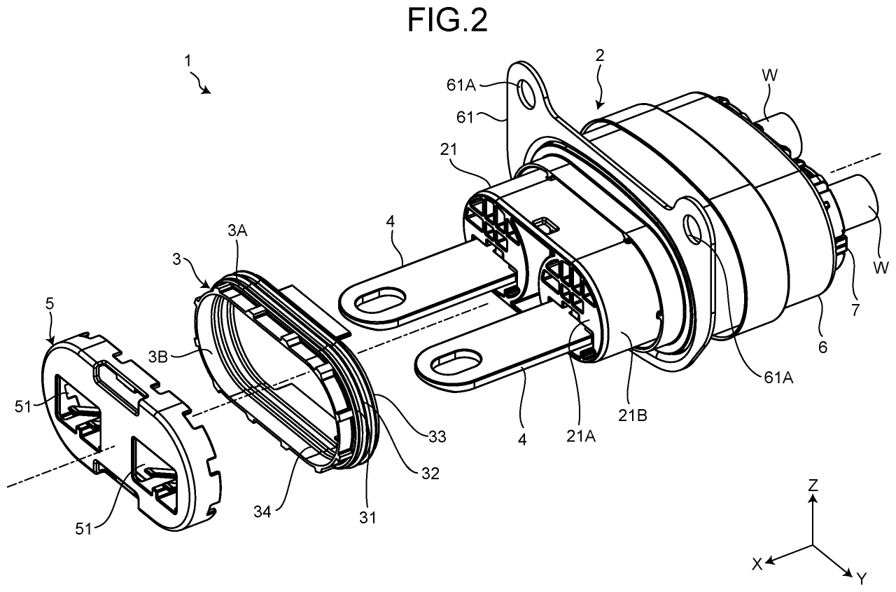

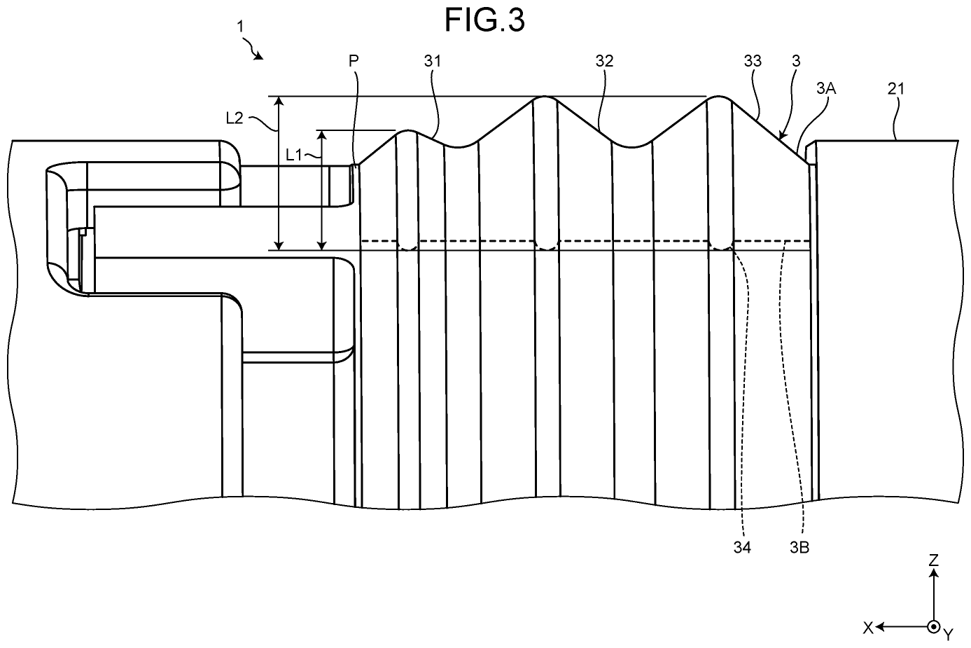

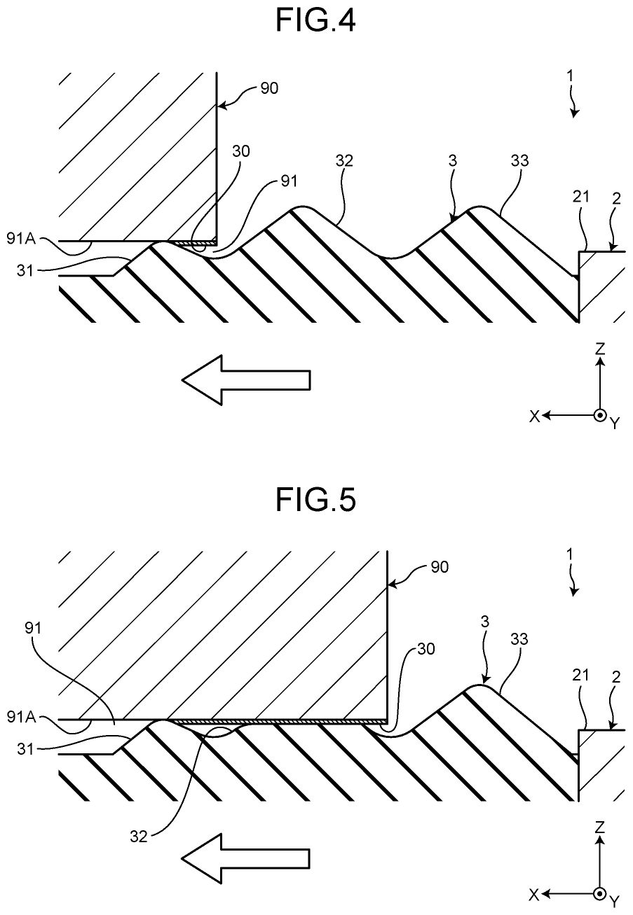

The present embodiment relates to a connector. FIG. 1 is a perspective view illustrating a connector according to the embodiment. FIG. 2 is an exploded perspective view illustrating the connector according to the embodiment. FIG. 3 is an enlarged view of a seal member of the connector according to the embodiment. FIG. 4 and FIG. 5 are sectional views taken along IV-IV line in FIG. 1, which are explanatory diagrams when connecting the connector according to the embodiment.

In the description hereinafter, in regards to a first direction, a second direction, and a third direction intersecting with each other, the first direction is referred to as a “connection direction X”, the second direction as a “width direction Y”, and the third direction as a “height direction Z”. Herein, the connection direction X, the width direction Y, and the height direction Z are orthogonal to each other. The connection direction X corresponds to the connection direction between the connector and a connection target and the insertion direction of the connector. The width direction Y and the height direction Z correspond to intersecting directions that intersect with the connection direction X. Furthermore, unless otherwise noted, each of the directions used in the following description represents the direction in a state where components are mounted to each other. Note that orthogonal herein includes almost orthogonal.

As illustrated in FIG. 1, a connector 1 is a connection device used for connection to a connection target 90, and it includes a housing 2 and a seal member 3. The connector 1 is used by being loaded on a vehicle, for example.

The housing 2 is a member that holds a terminal 4 to be connected to the connection target 90, and includes a fitting part 21 that is inserted into a fitting hole 91 formed in the connection target 90. The housing 2 holds two terminals 4 lined in the width direction Y, for example, with the terminals 4 extending out from an end face 21A of the fitting part 21 toward the connection direction X. Each of the terminals 4 is attached to a wire W in the housing 2. The fitting part 21 is a part extending out toward the connection target 90 side along the connection direction X and is formed in accordance with the shape of the fitting hole 91 that has a long cross-sectional shape in the width direction Y such as an elliptical or oval cross-sectional shape, for example.

The connection target 90 is a device to be connected to the connector 1, which corresponds to an electrical device, a battery, and the like, for example. The connection target 90 may also be a mating connector that is attached to an electrical device, a battery, and the like. For convenience of explanation, FIG. 1 illustrates the connection target 90 to be in a cuboid shape. The fitting hole 91 is a hole for inserting the terminals 4 and the fitting part 21, and it is formed to have an elliptical or oval shaped cross section in the direction intersecting with the connection direction X, for example.

For example, a surface treatment for anti-rusting may be applied on an inner face 91A of the fitting hole 91. Specifically, in a case where the part forming the fitting hole 91 in the connection target 90 is formed with a metal having aluminum as the main component, anodizing may be performed on the inner face 91A of the fitting hole 91. Anodizing is a treatment that forms an oxide film on the inner face 91A. In this case, the fitting hole 91 becomes less likely to rust, and the connection state of the connector 1 is maintained in good condition. However, anodizing increases the surface roughness of the inner face 91A, which results in roughening the surface of the inner face 91A. It is concerned that this may worsen the sliding property between the fitting hole 91 and the seal member 3, and increase the insertion force when connecting the connector 1.

The seal member 3 is attached to the outer periphery of the fitting part 21. The seal member 3 is a water sealing member or a packing that stops water between the housing 2 and the connection target 90, and it is formed in an annular shape. The seal member 3 is formed with an elastic member that is elastically deformable and impregnated with oil. For example, the seal member 3 is formed with oil-impregnated silicone rubber, oil-impregnated nitrile rubber, or the like. Therefore, the seal member 3 allows oil 30 contained inside thereof to seep out to the surface.

As illustrated in FIG. 3, the seal member 3 has a first lip 31, a second lip 32, and a third lip 33 formed therein. The first lip 31, the second lip 32, and the third lip 33 are lips formed on the outer periphery side of the seal member 3, which come in contact with the connection target 90 to stop water. The first lip 31, the second lip 32, and the third lip 33 are provided by being lined along the connection direction X, and are provided in order of the first lip 31, the second lip 32, and the third lip 33 from the connection target 90 side. In other words, when the fitting part 21 is inserted into the fitting hole 91 of the connection target 90, the first lip 31, the second lip 32, and the third lip 33 come in contact with the inner face 91A of the fitting hole 91 in order of the first lip 31, the second lip 32, and the third lip 33. Since the seal member 3 is formed with an oil-impregnated elastic member, the first lip 31, the second lip 32, and the third lip 33 are also oil-impregnated and allow the oil 30 to seep out from the surface.

The first lip 31, the second lip 32, and the third lip 33 protrude from an outer peripheral face 3A of the seal member 3, and are formed to have a mountain-shaped cross section tapered toward the tip, for example. A protrusion length L1 of the first lip 31 is shorter than a protrusion length L2 of the second lip 32 and the third lip 33. In other words, the first lip 31 is formed lower and has a lower tip position compared to the second lip 32 and the third lip 33.

For example, the first lip 31 protrudes to the position of the inner face 91A of the fitting hole 91, and the second lip 32 and the third lip 33 protrude longer than the position of the inner face 91A of the fitting hole 91. In other words, the first lip 31 is set such that the position of the tip comes at the position of the inner face 91A of the fitting hole 91, when the fitting part 21 is inserted into the fitting hole 91. Furthermore, the second lip 32 and the third lip 33 are set to be longer than the position of the inner face 91A of the fitting hole 91, when the fitting part 21 is inserted into the fitting hole 91. In other words, the first lip 31 is designed to protrude to the position of the inner face 91A of the fitting hole 91, and it protrudes to the position of the inner face 91A. Therefore, when the fitting part 21 is inserted into the fitting hole 91, the deformation degree of the first lip 31 caused by the contact with the inner face 91A of the fitting hole 91 is smaller than those of the second lip 32 and the third lip 33. Note here that the position of the inner face 91A includes approximate position of the inner face 91A.

While the protrusion length L1 and the protrusion length L2 are illustrated in FIG. 3 as the lengths from the tip of a lip 34 on the inner periphery side to the tips of the first lip 31, the second lip 32, and the third lip 33 on the outer periphery side, the protrusion lengths may also be defined as the lengths from a position P of the outer peripheral face 3A where the first lip 31, the second lip 32, and the third lip 33 are not formed to the tips of the first lip 31, the second lip 32, and the third lip 33. The lip 34 on the inner peripheral face side is a lip protruding from an inner peripheral face 3B of the seal member 3, and it is a part that comes in contact with an outer peripheral face 21B of the fitting part 21 to stop water.

As illustrated in FIG. 2, the connector 1 includes a front holder 5, a shield shell 6, and a rear holder 7. The front holder 5 is a holding member that holds the seal member 3. An insertion hole 51 for inserting the terminal 4 is formed in the front holder. The insertion hole 51 is formed in accordance with the number of provided terminals 4, and there are two formed herein, for example. The front holder 5 is attached at the tip position of the fitting part 21, and prevents the seal member 3 from coming off from the fitting part 21. The shield shell 6 is a cover member or a case member covering the housing 2, and covers the outer peripheral part of the housing 2 except for the fitting part 21. The shield shell 6 is formed with a metal, for example, and functions as an electromagnetic shield. The shield shell 6 has a flange part 61. The flange part 61 is a plate-like part extending in a direction intersecting with the connection direction X, and has fastening holes 61A used for being fastened to the connection target 90. The rear holder 7 is a holding member attached to the back of the housing 2, and holds a packing (not illustrated) that is mounted to the outer periphery of the wire W.

Next, connection of the connector 1 according to the present embodiment will be described.

As illustrated in FIG. 1, when connecting the connector 1 to the connection target 90, first, the connector 1 is disposed to face the connection target 90. In other words, the connector 1 is disposed with the terminals 4 and the fitting part 21 facing the fitting hole 91 of the connection target 90. Then, the connector 1 is brought closer to the connection target 90, the terminals 4 are inserted into the fitting hole 91, and then the fitting part 21 is inserted into the fitting hole 91.

As illustrated in FIG. 4, when the fitting part 21 is inserted into the fitting hole 91, the seal member 3 moves toward the connection direction X while contacting the inner face 91A of the fitting hole 91. In the seal member 3, the first lip 31 first comes in contact with the inner face 91A. The first lip 31 is formed with an oil-impregnated elastic member, thereby creating a state where the oil 30 is seeping to the surface. The first lip 31 moves with the oil 30 being attached to the inner face 91A. At this time, since the protrusion length L1 is short, the first lip 31 is suppressed from being deformed greatly even when it comes in contact with the inner face 91A. Therefore, the first lip 31 can surely have the oil 30 attached to the inner face 91A along the connection direction X.

Here, if the first lip 31 is formed in the same protrusion length L2 as the second lip 32 and the third lip 33, the first lip 31 is pressed strongly by the inner face 91A and deformed greatly. In this case, a large amount of the oil 30 seeps out of the first lip 31 at the entrance of the fitting hole 91, which makes it difficult to properly apply the oil 30 continuously to the position on the far side of the fitting hole 91. As a result, the coefficient of friction between the subsequent second lip 32 and third lip 33 and the inner face 91A is not sufficiently reduced. In other words, the sliding resistance of the second lip 32 and the third lip 33 against the inner face 91A increases, and the second lip 32 and the third lip 33 are dragged and caught without sliding against the inner face 91A. This increases the insertion force when connecting the connector 1.

Thus, in the connector 1 according to the present embodiment, the protrusion length L of the first lip 31 is set shorter than the protrusion length L2 of the second lip 32 and the third lip 33 to suppress deformation of the first lip 31. This allows the first lip 31 to continuously apply the oil 30 to the inner face 91A of the fitting hole 91 along the connection direction X, which makes it possible to reduce the coefficient of friction between the second lip 32 and the third lip 33 and the inner face 91A.

As illustrated in FIG. 5, in the connector 1 according to the present embodiment, the second lip 32 following the first lip 31 comes in contact with the inner face 91A of the fitting hole 91. The second lip 32 is pressed strongly by the inner face 91A and deformed greatly. However, since the oil 30 is attached in advance to the inner face 91A when the second lip 32 comes in contact with the inner face 91A, the coefficient of friction between the second lip 32 and the inner face 91A is reduced. Thereby, the second lip 32 with the reduced amount caught in the inner face 91A moves along the connection direction X while being deformed by making contact with the inner face 91A. In the same or nearly the same manner as the second lip 32, the third lip 33 with the reduced caught amount also moves along the connection direction X while being deformed by making contact with the inner face 91A. Therefore, the connector 1 according to the present embodiment can reduce the sliding resistance in the second lip 32 and the third lip 33, and reduce the insertion force for the connection target 90.

Then, when the fitting part 21 is inserted into the fitting hole 91 to a position set in advance, connection of the connector 1 to the connection target 90 is completed.

As described above, by providing the first lip 31 impregnated with oil with the small protrusion length L1, the connector 1 according to the present embodiment allows the oil 30 to attach to the inner face 91A of the fitting hole 91 of the connection target 90 to reduce the insertion force for the connection target 90. Therefore, with the connector 1 according to the present embodiment, connection to the connection target 90 can be achieved smoothly.

Furthermore, the connector 1 according to the present embodiment can surely have the oil 30 attached to the inner face 91A by the first lip 31 by protruding the first lip 31 to the position of the inner face 91A of the fitting hole 91. Therefore, with the connector 1 according to the present embodiment, connection to the connection target 90 can be achieved smoothly.

Furthermore, the connector 1 according to the present embodiment can reduce the insertion force for the connection target 90 by application of the oil 30 on the first lip 31, even when a surface treatment for anti-rusting is applied on the inner face 91A of the fitting hole 91 of the connection target 90 and the surface of the inner face 91A is rough. Therefore, with the connector 1 according to the present embodiment, connection to the connection target 90 can be achieved smoothly.

Note that the connector according to the present invention is not limited to the embodiment described above, and various changes are possible within the scope of the appended claims. Furthermore, the connector 1 according to the present embodiment may be configured by combining the structural components of the embodiment described above as appropriate.

For example, in the connector 1 according to the embodiment described above, the seal member 3 includes three lips that are the first lip 31, the second lip 32, and the third lip 33. However, it may be in a configuration where the third lip 33 is omitted, and two lips that are the first lip 31 and the second lip 32 are provided. Furthermore, in addition to the first lip 31, the second lip 32, and the third lip 33, the connector 1 according to the embodiment described above may be configured with a single or a plurality of additional lips in the same protrusion length L2 as the second lip 32 and the third lip 33 to have four or more lips provided therein. Moreover, in the connector 1 according to the embodiment described above, a lip in the same protrusion length L1 as the first lip 31 may be provided adjacent to the first lip 31. With such connectors, the same effects as those of the connector 1 according to the embodiment described above can be acquired. In other words, with those connectors, connection to the connection target 90 can be achieved smoothly by providing the first lip 31 that is impregnated with oil and formed in the short protrusion length L1.

Furthermore, while the case where the first lip 31 protrudes to the position of the inner face 91A is described in the embodiment above, the first lip 31 may be formed to protrude longer than the position of the inner face 91A. For example, the same effects as those of the connector 1 according to the embodiment described above can be acquired as long as the first lip 31 protrudes shorter than the second lip 32 and the third lip 33, and the degree of deformation upon contact with the inner face 91A is smaller than those of the second lip 32 and the third lip 33. In other words, the oil 30 can be applied to the inner face 91A by the first lip 31, thereby making it possible to achieve connection to the connection target 90 smoothly.

Moreover, while anodizing is described in the embodiment above as the surface treatment applied on the inner face 91A of the fitting hole 91, surface treatments other than anodizing for increasing the surface roughness of the inner face 91A may be applied as well. Even in such cases, it is also possible to acquire the effect of achieving connection to the connection target 90 smoothly as in the case of the connector 1 according to the embodiment described above.

Furthermore, while the case of loading the connector 1 according to the embodiment above on a vehicle is described, it may also be used without being loaded on a vehicle.

According to the connector of the present embodiment, connection to the connection target can be achieved smoothly.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing that holds a terminal connected to a connection target, the housing including a fitting part that is inserted into a fitting hole formed in the connection target; and
a seal member that is attached to an outer periphery of the fitting part, the seal member coming in contact with an inner face of the fitting hole to stop water between the housing and the connection target, wherein
the seal member is formed with an oil-impregnated elastic member, and includes at least a first lip and a second lip provided to protrude from an outer peripheral face while being lined along a connection direction with respect to the connection target,
the first lip is provided on the connection target side of the second lip, and
a protrusion length of the first lip is shorter than a protrusion length of the second lip.

2. The connector according to claim 1, wherein the first lip protrudes to a position of the inner face of the fitting hole.

3. The connector according to claim 1, wherein
a surface treatment for anti-rusting is applied on the inner face of the fitting hole of the connection target.

4. The connector according to claim 2, wherein
a surface treatment for anti-rusting is applied on the inner face of the fitting hole of the connection target.
